(19) United States
(12) Patent Application Publication
(10) Pub. No.: US 2024/0147325 A1
(43) Pub. Date: May 2, 2024

(54) PDU SET INFORMATION FORWARDING DURING MOBILITY EVENTS

(71) Applicant: QUALCOMM Incorporated, San Diego, CA (US)

(72) Inventors: Linhai HE, San Diego, CA (US); Dario Serafino TONESI, San Diego, CA (US); Prasad Reddy KADIRI, San Diego, CA (US)

(21) Appl. No.: 18/469,228

(22) Filed: Sep. 18, 2023

Related U.S. Application Data
(60) Provisional application No. 63/381,751, filed on Oct. 31, 2022.

(51) Int. Cl. H04W 36/02

(52) U.S. Cl. CPC H04W 36/0235

(57) ABSTRACT

A target cell receives a handover message originating from a source cell for a user equipment (UE) and receives buffered data for one or more protocol data unit (PDU) Sets in transition between the source cell and the UE. The target cell receives PDU Set information for the one or more PDU Sets and communicates with the UE based on the PDU Set information for the one or more PDU Sets. A source cell sends or receives a portion of a PDU Set with a UE. The apparatus initiates a handover of the UE to a target cell, provides buffered data for the PDU Set to the target cell, and provides PDU Set information for the PDU Set to the target cell.

### CROSS REFERENCE TO RELATED APPLICATION(S)

This application claims the benefit of and priority to U.S. Provisional Application Ser. No. 63/381,751, entitled “PDU Set Information Forwarding During Mobility Events” and filed on Oct. 31, 2022, which is expressly incorporated by reference herein in its entirety.

### TECHNICAL FIELD

The present disclosure relates generally to communication systems, and more particularly, to wireless communication including protocol data unit (PDU) sets.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a target cell. The apparatus receives a handover message originating from a source cell for a user equipment (UE) and receives buffered data for one or more protocol data unit (PDU) Sets in transition between the source cell and the UE. The apparatus receives PDU Set information for the one or more PDU Sets and communicates with the UE based on the PDU Set information for the one or more PDU Sets.

In an aspect of the disclosure, a method, a computer-readable medium, and an apparatus are provided for wireless communication at a source cell. The apparatus sends or receives a portion of a PDU Set with a UE. The apparatus initiates a handover of the UE to a target cell, provides buffered data for the PDU Set to the target cell, and provides PDU Set information for the PDU Set to the target cell.

In an aspect of the disclosure, a method, a computer-readable medium, and an apparatus are provided for wireless communication at a UE. The apparatus sends a portion of an uplink PDU Set to a source cell, provides PDU Set information for the uplink PDU Set to a target cell to which the UE is being handed over from the source cell and transmits a remaining portion of the uplink PDU Set to the target cell after a handover to the target cell.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating timing aspects of extended reality (XR) traffic.

FIG. 5 is a diagram illustrating aspects of PDU Sets, in accordance with various aspects of the present disclosure.

FIG. 6 illustrates a communication flow including a handover of a UE from a source cell to a target cell and the communication of PDUs in a PDU set, in accordance with various aspects of the present disclosure.

FIG. 7 illustrates a communication flow including a handover of a UE from a source cell to a target cell and the communication of PDUs in a PDU set, in accordance with various aspects of the present disclosure.

FIG. 8 illustrates a communication flow including a handover of a UE from a source cell to a target cell and the communication of PDUs in a PDU set, in accordance with various aspects of the present disclosure.

FIG. 9 illustrates a communication flow including a handover of a UE from a source cell to a target cell and the communication of PDUs in a PDU set, in accordance with various aspects of the present disclosure.

FIG. 10 is a flowchart of a method of wireless communication at a target cell, in accordance with various aspects of the present disclosure.

FIG. 11 is a flowchart of a method of wireless communication at a source cell, in accordance with various aspects of the present disclosure.

FIG. 12 is a flowchart of a method of wireless communication at a UE, in accordance with various aspects of the present disclosure.

FIG. 13 is a diagram illustrating an example of a hardware implementation for an example apparatus and/or UE.

FIG. 14 is a diagram illustrating an example of a hardware implementation for an example network entity.

FIG. 15 is a diagram illustrating an example of a hardware implementation for an example network entity.

### DETAILED DESCRIPTION

A PDU Set is a set or group of PDUs that are delivered as an integrated unit between a radio access network (RAN) and an application at a UE. For example, the PDUs in the PDU Set share common quality of service (QoS) attributes such as a PDU set delay budget (PSDB), a PDU Set error rate (PSER), among other examples of QoS attributes that may be common for the PDUs of the PDU Set. An example of a PDU Set is data for a video frame or for a slice within a video frame. Different PDU sets may have different types of decoding criteria, which may be referred to as PDU Set content criteria. As a first example of a decoding criteria (or PDU Set content criteria), if any PDU in the PDU set is lost (e.g., not accurately received at a receiver), the whole PDU set may become obsolete. As a second example of a decoding criteria (or PDU Set content criteria), the received PDUs of the PDU set may be considered good, e.g. may be used by an application, until a first PDU loss occurs (e.g., until a first PDU in the PDU set is lost or not received by the receiver). As a third example of a decoding criteria (or PDU Set content criteria), PDUs in the PDU set may be encoded using an application layer forward error correction (AL-FEC), and based on the redundancy ratio of the FEC, the PDUs in the PDU Set may be decoded when a subset of the PDUs are lost or not received. In this example, the use of the AL-FEC may enable the PDU set to be decoded based on a subset of PDUs in the PDU Set.

PDUs may be discarded by the UE and/or by the RAN based on a delay budget and/or loss criteria. The UE and the RAN may maintain PDU Set state information as part of receiving and decoding PDUs of a PDU Set. Some events may lead to a change in a connection between the network and a UE. Aspects presented herein enable a target cell in a handover for the UE to obtain PDU Set state information for ongoing PDU sets (e.g., PDU sets that are in transition) between a source cell and the UE. The target cell may receive buffered PDUs, and may use the PDU Set state information to continue communication with the UE for the PDU Set. The aspects presented herein improve the reliability of the communication with the network, e.g., and helps to avoid dropping PDU Sets when a handover occurs. The added reliability improves a user experience. As an example, the reliability of the transmission and reception of PDUs for XR wireless communication can have a significant influence on the XR user experience, which can be improved through the aspects of the present disclosure.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

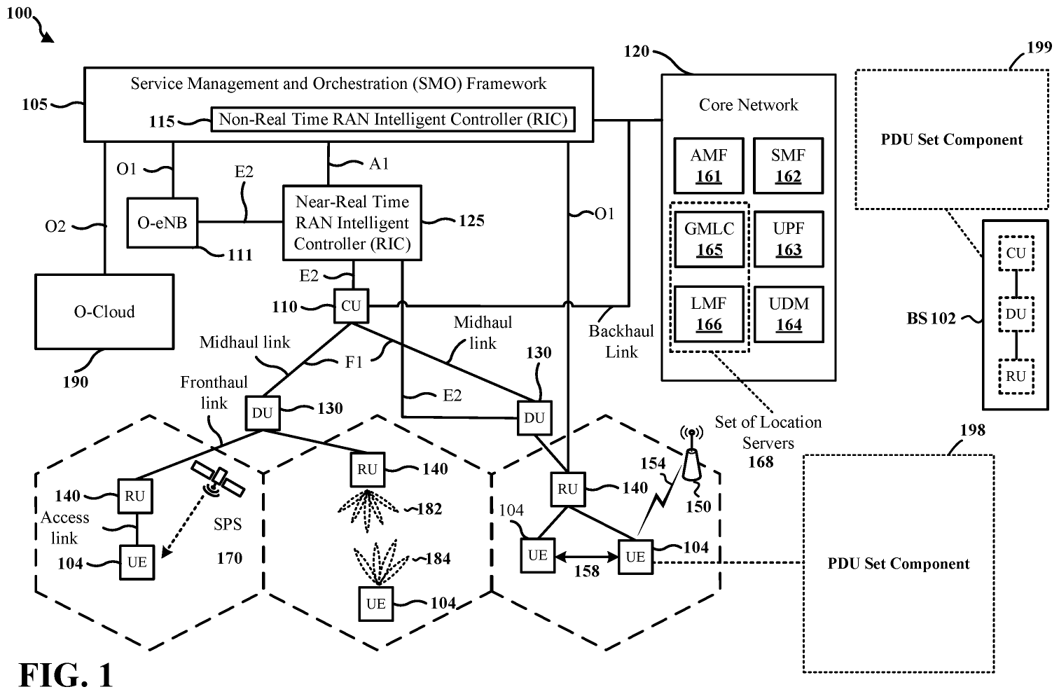

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi™ AP 150 in communication with UEs 104 (also referred to as Wi-Fi™ stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may be configured to include a PDU set component 198 configured to send a portion of an uplink PDU Set to a source cell, provide PDU Set information for the uplink PDU Set to a target cell to which the UE is being handed over from the source cell and transmit a remaining portion of the uplink PDU Set to the target cell after a handover to the target cell, e.g., as described in various aspects of the present disclosure. In some aspects, e.g., when the base station is a target cell in a handover, the base station 102 may include a PDU set component 199 configured to receive a handover message originating from a source cell for a UE 104, receive buffered data for one or more PDU Sets in transition between the source cell and the UE 104, receive PDU Set information for the one or more PDU Sets and communicate with the UE 104 based on the PDU Set information for the one or more PDU Sets. The PDU Set component 199 may be configured to, e.g., when the base station 102 is a source cell in a handover, send or receive a portion of a PDU Set with a UE. The apparatus initiates a handover of the UE to a target cell, provide buffered data for the PDU Set to the target cell, and provide PDU Set information for the PDU Set to the target cell. Although the following description may be focused on 5G NR, the concepts described herein may be applicable to other similar areas, such as LTE, LTE-A, CDMA, GSM, and other wireless technologies.

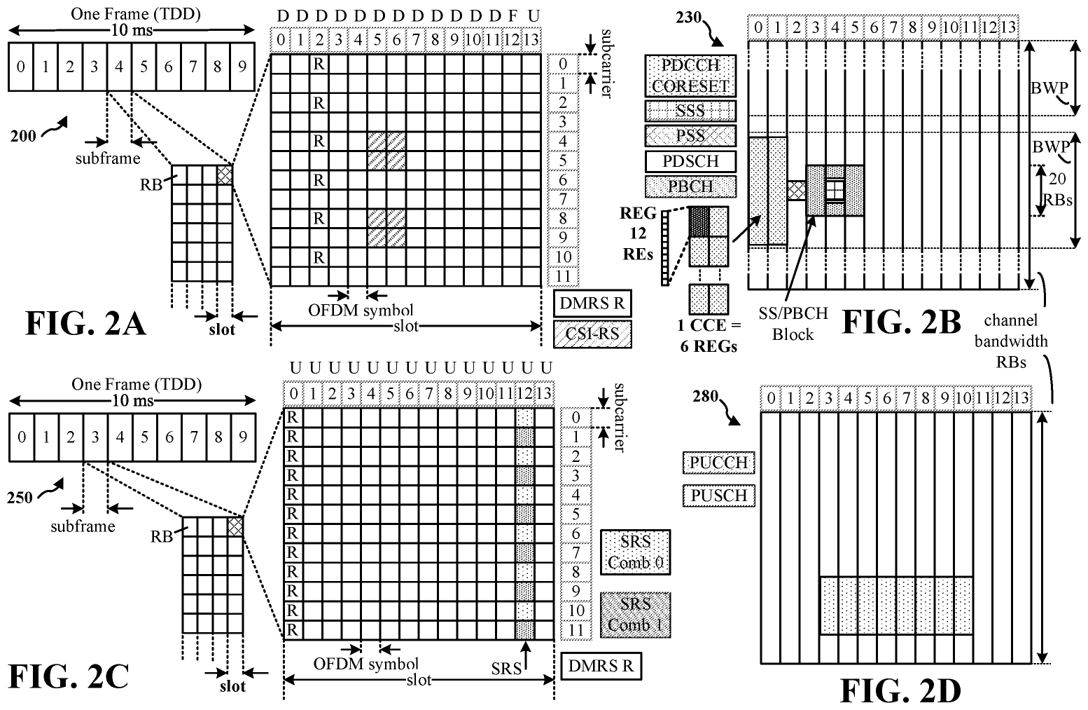

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [KHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

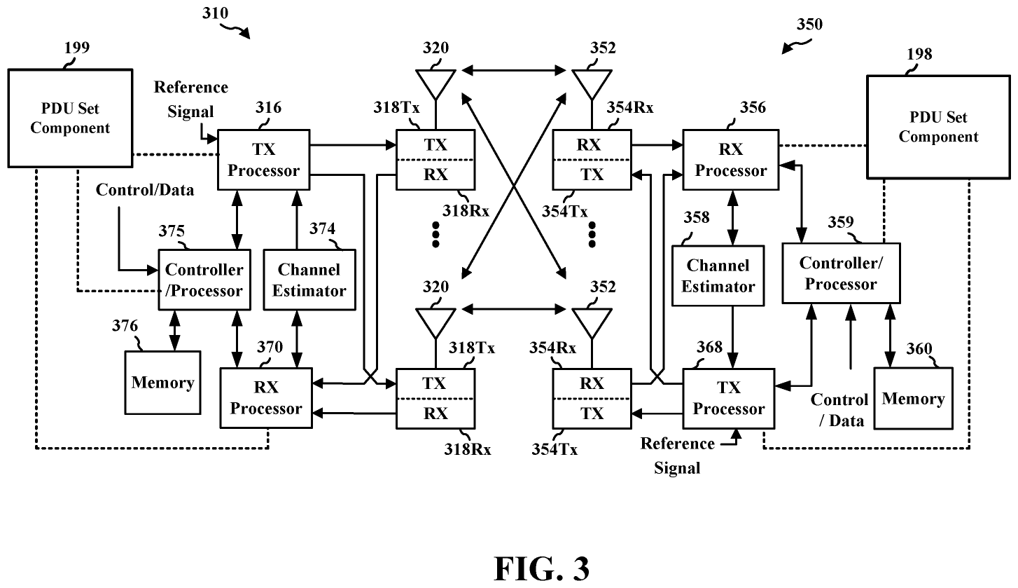

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 (or processor circuitry) can be associated with at least one memory 360 (or memory circuitry) that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 (or processor circuitry) can be associated with at least one memory 376 (or memory circuitry) that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PDU set component 198 of FIG. 1.

At least one of the TX processor 316, the RX processor 370, and the controller/processor 375 may be configured to perform aspects in connection with the PDU set component 199 of FIG. 1.

Wireless communication systems may support various types of wireless traffic. Different wireless traffic may be associated with different latency, reliability, quality of service (QoS), etc. An example of a type of wireless traffic is extended reality (XR) traffic.

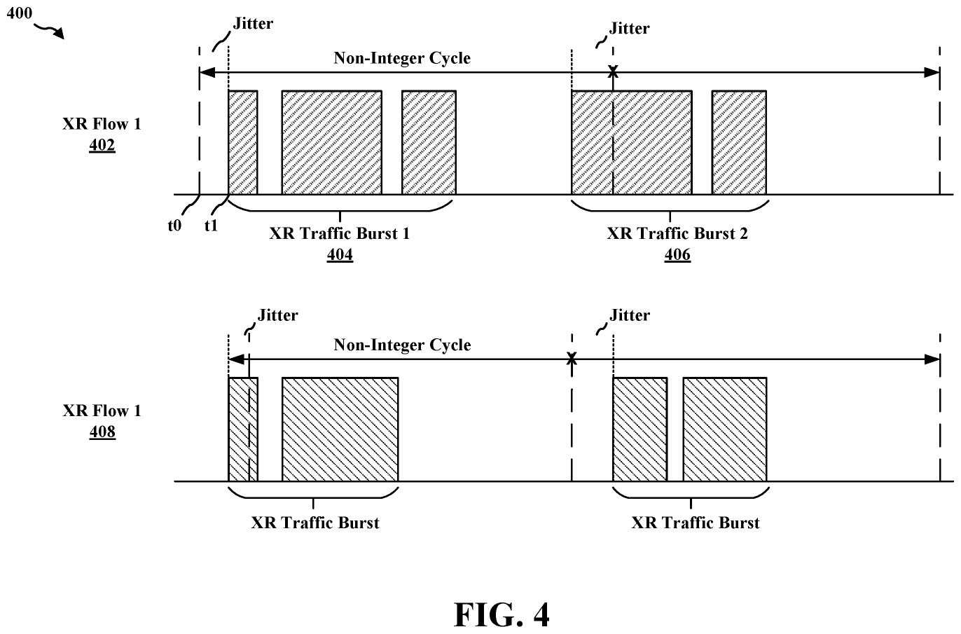

FIG. 4 is a diagram 400 illustrating example XR traffic. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

XR traffic may have an associated packet delay budget (PDB). If a packet does not arrive within the PDB, a UE (or a base station) may discard the packet. In an example, if a packet corresponding to a video frame of a video does not arrive at a UE within a PDB, the UE may discard the packet, as the video has advanced beyond the frame.

In general, XR traffic may be characterized by relatively high data rates and low latency. The latency in XR traffic may affect the user experience. For instance, XR traffic may have applications in eMBB and URLLC services.

Some applications may generate multiple types of uplink flows of data. Different flows may have different timing deadlines. For example, different data flows for the same application may have different packet delay budgets. A non-limiting example of such an application is an extended reality (XR) application (e.g., or similarly a virtual reality (VR) application or augmented reality application) or a different type of cloud-type gaming application. In an XR example, the XR application may generate pose or control packets of information that may have a packet delay budget of 4 ms, and which may arrive for transmission (e.g., be generated) with a period of 10 ms. Such pose data may be based on movement of a user's head, a user's field of vision, etc. For example, the application may sample the head position every 10 ms and generate an update to send to the other end of the application (such as a cloud-based server). The XR application may also generate hand gesture tracking information to track movement of a player's hand, and which may have a longer packet delay budget of 10 ms and may arrive for transmission every 40 ms (e.g., with a period of 40 ms). The XR application may generate voice or audio for transmission, which may have a longer delay budget of 15 ms and may arrive for transmission with a period of 20 ms. In this example, the XR application may generate different flows of traffic that may have different packet delay budgets and different generation periods.

The reliability of wireless communication, such as data exchanged for an XR application affects the user experience. For example, the loss of PDUs or the interruption of PDU sets can lead to an interruption or delay in the XR experience, which may affect the user satisfaction with the XR application. As an example, video for an XR application may have a periodic pattern, e.g., with a video frame to be sent or received within each period. A loss of a PDU set with video frame data may lead to an interruption of the video for the XR application, which can reduce the quality of the XR user experience.

A PDU Set is a set or group of PDUs that are delivered as an integrated unit between a RAN and an application at a UE. For example, the PDUs in the PDU Set share common QoS attributes such as a PDU set delay budget (PSDB), a PDU Set error rate (PSER), among other examples of QoS attributes that may be common for the PDUs of the PDU Set. An example of a PDU Set is data for a video frame or for a slice within a video frame.

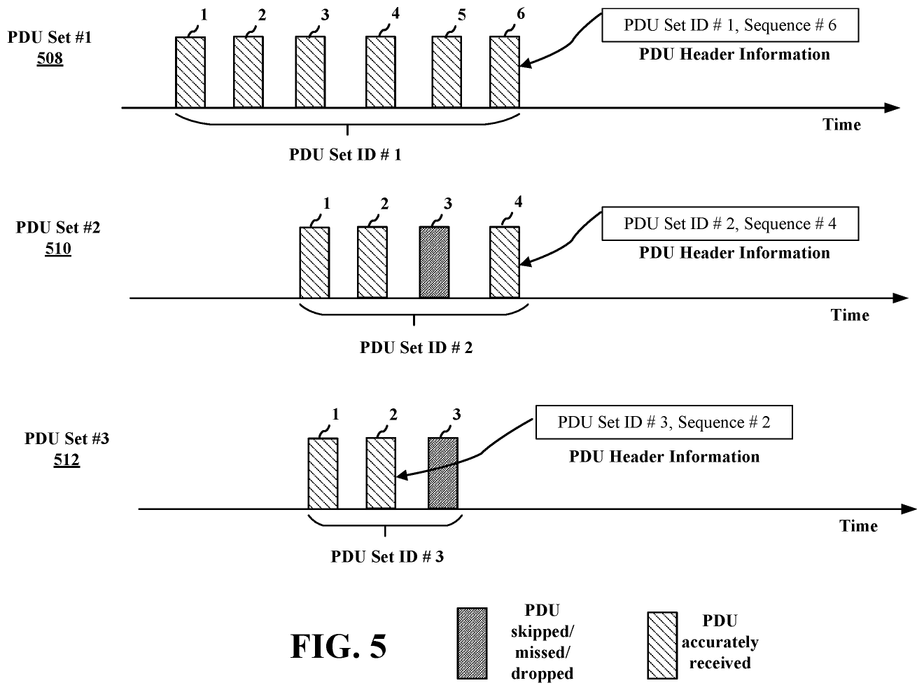

FIG. 5 illustrates various examples of PDU Sets. As illustrated in FIG. 5, the PDU sets may have different sizes, e.g., different numbers or sequences of PDUs. FIG. 5 illustrates that each PDU of the PDU Set may include header information that identifies a PDU set (e.g., with a PDU set identifier (ID)) and a sequence number of the PDU within the set. For example, for PDU Set #1 (e.g., 508), the PDU set includes 6 PDUs. A header for the sixth PDU may indicate PDU Set #1 and Sequence number 6 so that the receiver of the PDU (or feedback for the PDU) will be able to identify the PDU as the 6^{th} PDU in the PDU set #1. FIG. 5 also shows PDU Set #2 (e.g., 510) having 4 PDUs. The header for the fourth PDU may indicate a PDU Set ID for PDU Set #2 and a sequence number of 4. FIG. 5 also shows PDU Set #3 (e.g., 512) having 3 PDUs. The header for the second PDU may indicate a PDU Set ID for PDU Set #3 and a sequence number of 2. The sequence number carries meaning relative to the order within the corresponding PDU Set, and does not uniquely identify the PDU outside of the PDU Set. FIG. 5 illustrates that one or more PDUs within a PDU set may not be accurately received by a receiver, e.g., which may be referred to herein as being lost.

Different PDU sets may have different types of decoding criteria, which may be referred to as PDU Set content criteria. In some aspects, the decoding criteria may be different for different applications, e.g., based on an individual application's implementation.

As a first example of a decoding criteria (or PDU Set content criteria), if any PDU in the PDU set is lost (e.g., not accurately received at a receiver), the whole PDU set may become obsolete. The first example may be referred to as an “all or nothing” decoding criteria or content criteria. For the all or nothing example, the PDU Set #2 and the PDU Set #3 in FIG. 5 may be discarded, because one of the PDUs was not accurately received.

As a second example of a decoding criteria (or PDU Set content criteria), the received PDUs of the PDU set may be considered good, e.g. may be used by an application, until a first PDU loss occurs (e.g., until a first PDU in the PDU set is lost or not received by the receiver). The second example may be referred to as a “good until the first loss” decoding criteria or content criteria. For the good until the first loss example, the first two PDUs of the PDU Set #2 and the PDU Set #3 may be considered good, as they are received prior to the lost/missed PDU in the PDU Set. The fourth PDU in the PDU set #2 may be discarded, because it follows the lost/missed PDU in the sequence within the PDU Set.

As a third example of a decoding criteria (or PDU Set content criteria), PDUs in the PDU set may be encoded using an application layer forward error correction (AL-FEC), and based on the redundancy ratio of the FEC, the PDUs in the PDU Set may be decoded when a subset of the PDUs are lost or not received. The application that is the source of the PDU Set may add redundancy into the original data. As one example to illustrate the concept, for 10 packets of data, 5 packet size of redundant data may be added to form 15 total packets. If a UE receives a subset of the 15 packets, e.g., such as 11 packets, the UE might be able to still obtain the original 10 packets of data based on the redundancy that was introduced. In this example, the use of the AL-FEC may enable the PDU set to be decoded based on a subset of PDUs in the PDU Set. The third example may be referred to as an AL-FEC decoding criteria or content criteria. As an example, in FIG. 5, the data from the PDU Set #3 might be able to be decoded with the first and second PDUs, even without the third PDU being accurately received, based on the redundancy provided by AL-FEC.

PDUs may be discarded by the UE and/or by the RAN based on a delay budget and/or loss criteria. A PDU may be discarded, for example, if a remaining delay budget (RDB) expires, or if another timer associated with the PDU expires. For example, the PDU may be discarded if an associated layer 2 (L2) timer, such as a PDCP discard timer, an RLC reassembly timer, an RLC discard timer, or a PDCP reordering timer expires. A PDU may be discarded, e.g., the network or the UE, based on the decoding criteria or content criteria of the associated PDU Set. For example, if the decoding criteria/content criteria for the PDU Set can no longer be met or has already been met, the UE or network may discard the associated PDUs (e.g., discard for transmission or reception/decoding). In some aspects, if a PDU loss occurs for a PDU Set having an “all or nothing” content criteria, the PDUs of the PDU Set may be discarded. In other aspects, if a threshold number of PDUs within an AL-FEC PDU Set have been received (so that the data can be decoded from the subset of PDUs), the subsequent PDUs may be discarded (e.g., not received or transmitted).

There is a dependency between PDUs in a PDU Set. The UE and the RAN may maintain PDU Set state information when handling a PDU Set, e.g., as part of transmitting, receiving, or decoding PDUs of the PDU Set. By maintaining the PDU Set state information, the transmitter or receiver may determine when a content criteria is met that leads to discarding PDUs of the PDU Set, e.g., whether the content criteria is based on a loss or AL-FEC decoding with a subset of PDUs.

Some events may lead to a change in a connection between the network and a UE. As an example, the UE may be mobile within a network and may experience a mobility event in which the UE changes to a different cell or has a reconfiguration of an RRC configuration with a synchronization event with the network. For example, the network may perform a handover to hand a UE over from service by a source cell to service by a target cell. In some aspects, a cell such as a primary secondary cell (PSCell) for the UE may change. As another example, a network may provide the UE with an RRC reconfiguration or an RRC re-establishment. In connection with the mobility event, a source base station may forward data for the UE that is stored in a buffer to a target base station for the UE. The forwarding of the buffered data may help to avoid data loss as the mobility event occurs. In some aspects, a tunnel may be set up between a source base station (or a source cell) and a target base station (or a target cell), and the source base station may forward the buffered data over the tunnel to the target base station, which may occur without additional user plane procedures.

Aspects presented herein enable a target cell in a handover for the UE to obtain PDU Set information for ongoing PDU sets (e.g., PDU sets that are in transition) between a source cell and the UE. For data that is provided as a PDU Set, such as for XR services, if data that is buffered at the source cell is associated with a PDU Set for which the PDUs are not fully transmitted or received, providing the information for the PDU Set to the target cell enables the target cell to properly handle the PDU Set. As an example, if a PDU n (e.g., number n in a sequence for the PDU Set) in a PDU Set has already been successfully sent by a source cell, the lowest sequence number of the PDUs that are forwarded to the target cell is PDU n+1. Without the PDU Set information, the target cell is unaware whether the lower numbered PDUs in the PDU Set sequence have been successfully transmitted, successfully received, or lost.

The aspects presented herein improve the reliability of the communication with the network, e.g., and help to avoid dropping PDU Sets when a handover occurs. The added reliability improves a user experience. As an example, the reliability of the transmission and reception of PDUs for XR wireless communication can have a significant influence on the XR user experience, which can be improved through the aspects of the present disclosure. For example, the loss of PDUs or the interruption of PDU sets can lead to an interruption or delay in the XR experience, which may affect the user satisfaction with the XR application. As presented herein, a target cell may receive buffered PDUs from a source cell, and may use the PDU Set information (e.g., that enables a maintenance of PDU Set state information) to continue communication with the UE for the PDU Set, including the application of decoding criteria or content criteria for the PDU Set.

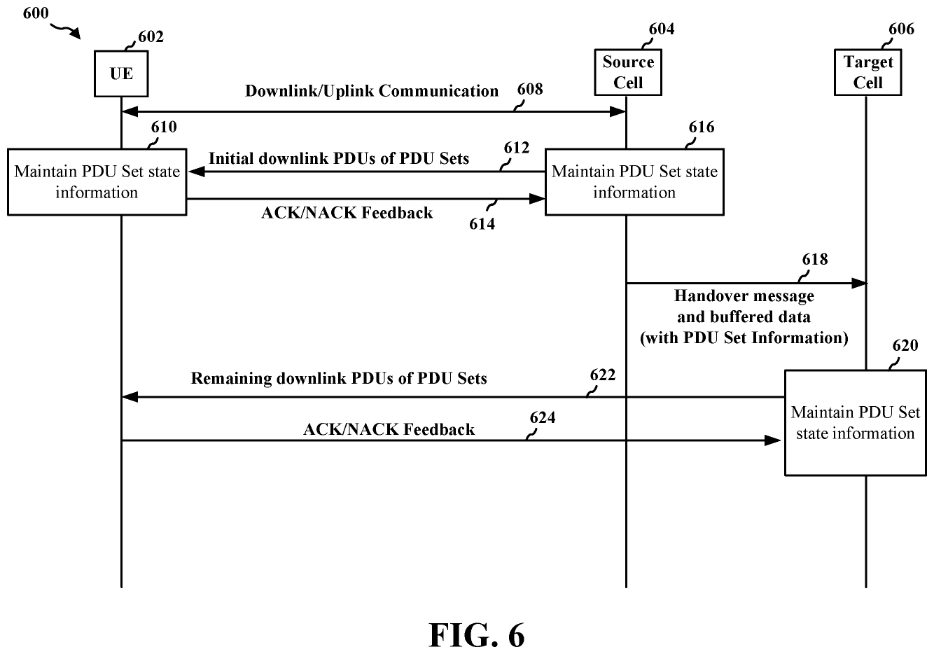

FIG. 6 illustrates a communication flow 600 between a UE 602, a source cell 604, and a target cell 606 for downlink PDU Sets in connection with a handover, or mobility event, for the UE 602. The aspects performed by the source cell may be performed by a network node, such as a base station or one or more components of a base station (such as a CU, DU, and/or RU). The aspects performed by the target cell may be performed by a network node, such as a base station or one or more components of a base station (such as a CU, DU, and/or RU).

The UE 602 and the source cell 604 exchange downlink and/or uplink communication 608. As shown at 612, the source cell starts to transmit PDUs of a downlink PDU Set to the UE 602. The UE 602 starts to receive the PDUs of the PDU set, at 612, and maintains PDU Set state information, at 610. The UE may be aware of the size of the PDU Set (e.g., the number of PDUs in the PDU Set) and of an identifier for the PDU Set (e.g., a PDU Set ID). Additionally, the header of each PDU in the PDU Set may include the PDU Set ID and a sequence number to indicate its place within the order to PDUs in the PDU Set ID, such as described in connection with FIG. 5. The UE may use decoding criteria/content criteria for the PDU Set to determine whether to discard one or more PDUs of the PDU set.

The UE 602 may provide feedback 614 (e.g., ACK/NACK feedback) to the source cell 604. The source cell 604 may maintain PDU Set State information, at 616. The state information for the PDU Set may be based on the PDUs within the PDU Set that have been transmitted, and may be based on the feedback 614 from the UE 602 that indicates the PDUs within the PDU Set that have been accurately received by the UE. The source cell may use the state information to determine whether to discard, e.g., and not transmit, one or more PDUs of the PDU Set. For example, if the UE has failed to receive a PDU for a PDU Set having an all or nothing content criteria or a good until the first loss content criteria, the source cell may discard the remaining PDUs and not transmit them. As another example, if the UE has received a subset of PDUs with AL-FEC that has enabled the UE to successfully decode the data based on redundancy, the source cell may discard the remaining PDU(s) and rather than transmit them. The downlink PDU Set may be partially transmitted when a handover event occurs for the UE. For example, the source cell may have transmitted a subset of the PDUs of the PDU Set, and may have remaining, PDUs of the PDU Set that remain for transmission. In some aspects, the PDU Set, for which transmission began at 612, may be referred to as “in transition” meaning that the transmission of the PDUs of the PDU Set has been begun, and there are remaining PDUs for transmission.

FIG. 6 shows a handover as an example of a mobility event. The source cell 604 may initiate the handover to a target cell 606, and may exchange one or more handover messages with the target cell 606. During the mobility event, when the source cell 604 forwards buffered downlink data (e.g., including PDUs for the PDU Set that is in transition) in a data radio bearer (DRB) that is associated with PDU Sets, the source cell 604 provides the PDU Set information for the PDU Set to the target cell, as shown in the handover message 618 from the source cell 604 to the target cell 606. In some aspects, the PDU Set information may be provided in a same message as the buffered data (e.g., remaining PDUs of the PDU Set). In other aspects, the PDU Set information may be provided in a separate message from the buffered data.

As part of the PDU Set information, the source cell 604 may provide PDU Set identifier(s) for each of the PDU Set(s) that have some of its PDUs already sent, or discarded, before the data forwarding from the source cell to the target cell starts (e.g., for each PDU Set in transition). There may be one or more PDU Sets in transition when the handover occurs. For each PDU Set in transition, the source cell 604 may provide the target cell 606 with an intra-PDU-Set sequence information, such as sequence number for a last transmitted PDU, a last discarded PDU, or a next expected PDU when the data forwarding starts. The intra-PDU-Set sequence number corresponds to a sequence number of the PDUs within the PDU set. It is unique within the PDU Set, and not unique across different PDU Sets.

In some aspects, the source cell 604 may provide a size of each PDU Set that is in transition, as part of the PDU Set information. The size may be signaled as a number of PDUs within the PDU set, a number of bytes of the PDU Set, or another indication of size. In other aspects, the size of the PDU set may be signaled in each header of the PDUs, as may be received by the target cell from the header rather than the source cell. In some aspects, the source cell 604 may provide a content criteria of each PDU Set in transition, as part of the PDU Set information. In other aspects, the content criteria may be either configured via control-plane signaling or signaled in PDU header rather than provided in a message from the source cell 604 to the target cell 606.

The target cell 606 may then use the buffered data and the PDU Set information to continue handling the downlink transmission of the remaining PDUs of the PDU Set(s) 622 that were in transition when the handover occurred. The target cell 606 may transmit one or more remaining PDUs, and maintain PDU set state information, at 620, to enable the target cell to handle the PDU sets according to the decoding criteria/content criteria. The target cell 606 may receive feedback 624 from the UE 602. The feedback may identify a corresponding PDU Set ID and a sequence number within the PDU Set. As the target cell has the PDU Set information from the source cell, the target cell may use the feedback to determine whether there has been a PDU within the PDU set that has not been accurately received by the UE and/or whether the UE has received a threshold number of PDUs in the PDU Set based on AL-FEC. The target cell 606 may continue to transmit PDUs of the PDU Set or may discard PDUs according to the content criteria for the PDU set and the state information (based on the received PDU Set information) for the PDU Set, similar to the handling described at 616. As the target cell has the PDU Set information for the PDU set, at 618, when the target cell receives the feedback from the UE, at 624, the target cell can consider it in connection with the received PDU Set information. If the target cell receives PDU Set information indicating that the last PDU transmitted before the handover was PDU #n (or that the next expected PDU is PDU #n+1), if the target cell receives feedback for PDU #n, the target cell may determine that no PDUs in the PDU Set have been lost and may continue to transmit the remaining PDUs.

The handover between the source cell 604 and the target cell 606 may be an Xn handover, for example. The PDU Set information, e.g., as provided at 618, may be included in an Xn handover request message, an Xn PDCP state transfer message, or an early status transfer message.

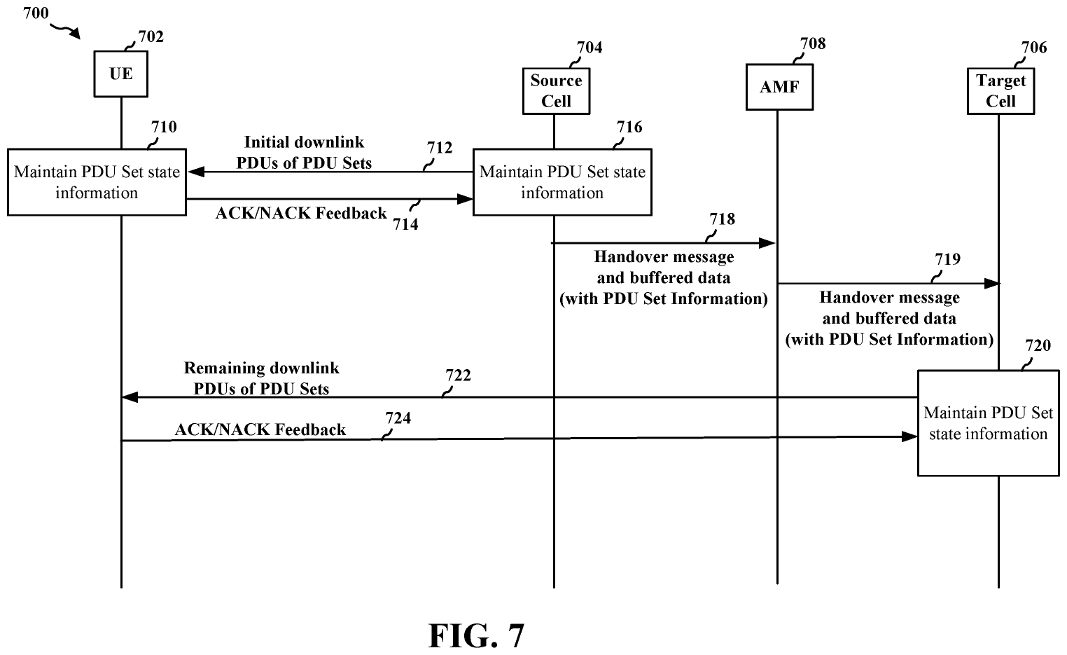

In other aspects, the handover may be an NG handover. FIG. 7 illustrates a communication flow 700 between a UE 702, a source cell 704, and a target cell 706, and an AMF 708 for downlink PDU Sets in transition when an NG handover occurs. The aspects performed by the source cell may be performed by a network node, such as a base station or one or more components of a base station (such as a CU, DU, and/or RU). The aspects performed by the target cell may be performed by a network node, such as a base station or one or more components of a base station (such as a CU, DU, and/or RU).

Although not illustrated in FIG. 7, the UE 702 and the source cell 704 may exchange downlink and/or uplink communication prior to the handover. As shown at 712, the source cell 704 starts to transmit PDUs of a downlink PDU Set to the UE 702, and the UE provides feedback 714, which may include any of the aspects described for 612 and 614. The UE maintains PDU Set state information, at 710, and the source cell maintains the PDU Set state information, at 716, such as described in connection with 610 and 616 in FIG. 6.

The source cell 704 initiates a handover to a target cell 706, by providing a handover message to the AMF 708. The AMF 708 provides one or more handover messages to the target cell 706. The source cell 704 may provide buffered data and PDU Set information, as described in connection with 618, to the AMF at 718. The AMF 708 may provide the buffered data and PDU Set information to the target cell at 719. The PDU Set information may be included in an NG handover required message from the source cell 704 to the AMF 708 or may be included in an NG AP handover request message. The target cell 706 may use the PDU Set information received at 719 to maintain PDU Set state information, at 720 and to handle the remaining PDUs of the PDU Sets in transition when the handover occurred, as shown at 722. The UE may provide feedback at 724, which the target cell interprets in view of the received PDU Set information for the PDU Set(s).

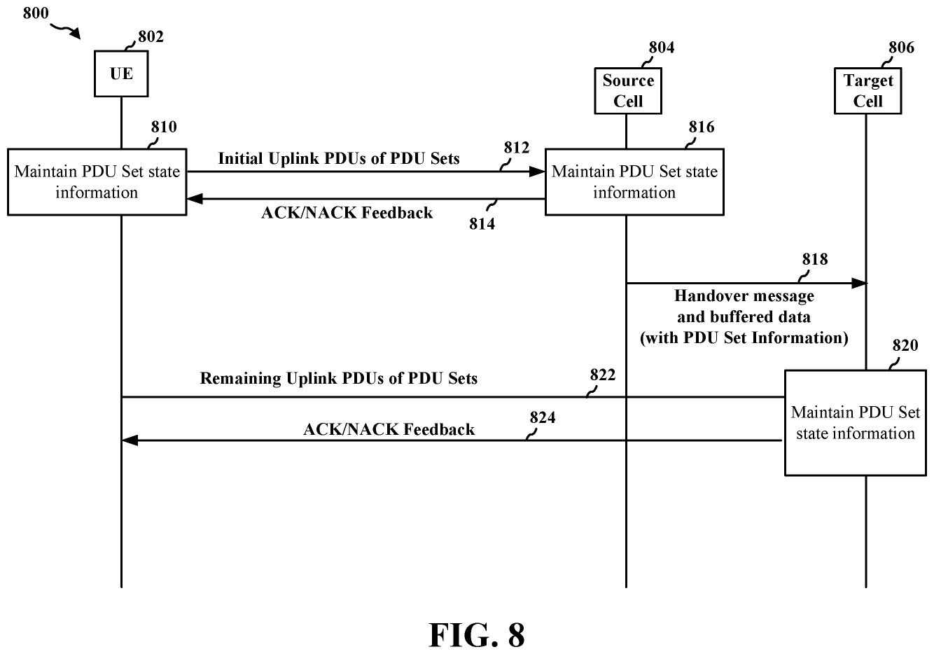

FIG. 8 illustrates a communication flow 800 between a UE 802, a source cell 804, and a target cell 806 for uplink PDU Sets in connection with a handover, or mobility event such as an Xn handover, for the UE 802. The aspects performed by the source cell may be performed by a network node, such as a base station or one or more components of a base station (such as a CU, DU, and/or RU). The aspects performed by the target cell may be performed by a network node, such as a base station or one or more components of a base station (such as a CU, DU, and/or RU).

The UE 802 and the source cell 804 may exchange downlink and/or uplink communication prior to the handover, such as illustrated in FIG. 6 at 608. As shown at 812, the UE 802 starts to transmit PDUs of an uplink PDU Set to the source cell 804. The UE 802 maintains PDU Set state information, at 810. The UE may use decoding criteria/content criteria for the PDU Set to determine whether to discard one or more PDUs of the PDU set. For example, if feedback 814 indicates that the source cell 804 failed to receive a PDU for a PDU Set having an all or nothing content criteria or a good until the first loss content criteria, the UE 802 may discard the remaining PDUs and not transmit them. As another example, if the feedback 814 indicates, or the UE otherwise determines, that the source cell 804 has received a subset of PDUs with AL-FEC that has enabled successfully decoding of the data based on redundancy, the UE 802 may discard the remaining PDU(s) and rather than transmit them. The source cell 804 may similarly maintain PSU Set state information, at 816, e.g., and use the information to determine whether to discard or continue to attempt to decode the PDUs. The uplink PDU Set may be partially transmitted when a handover event occurs for the UE 802, such as described in connection with the downlink PDU set in FIG. 6. For example, the UE 802 may have transmitted a subset of the PDUs of the PDU Set, and may have remaining, PDUs of the PDU Set that remain for transmission.

The source cell 804 may initiate the handover to a target cell 806, and may exchange one or more handover messages with the target cell 806. The source cell 804 may forward buffered data to the target cell, e.g., as shown at 818. Similar to the example in FIG. 6, the PDU Set information, e.g., which may include PDU Set state information, may be exchanged between the source cell 804 and the target cell 806.

For example, during a mobility event, after the source cell 804 receives confirmation for its request for RRC Reconfiguration with Synchronization from the target cell 806, then for each DRB which is associated with PDU Sets, the source cell 804 may provide the appropriate PDU Set information to the target cell 806, at 818. Similar to the information provided at 618, as part of the state information, at 818, for the PDU Set, the source cell 804 may provide PDU Set identifier(s) for each of the PDU Set(s) that have some of its PDUs already received, or discarded, before the data forwarding from the source cell to the target cell starts (e.g., for each uplink PDU Set in transition). There may be one or more PDU Sets in transition when the handover occurs. For each PDU Set in transition, the source cell 804 may provide the target cell 606 with an intra-PDU-Set sequence information, such as sequence number for a next expected PDU that the source cell 804 expects to receive when the data forwarding starts. The intra-PDU-Set sequence number corresponds to a sequence number of the PDUs within the PDU set.

In some aspects, the source cell 804 may provide a size of each uplink PDU Set that is in transition, as part of the PDU Set information for the PDU set(s). The size may be signaled as a number of PDUs within the PDU set, a number of bytes of the PDU Set, or another indication of size. In other aspects, the size of the PDU set may be signaled in each header of the PDUs, as may be received by the target cell from the header rather than the source cell. In some aspects, the source cell 804 may provide a content criteria of each uplink PDU Set in transition, as part of the PDU Set information for the PDU set(s). In other aspects, the content criteria may be either configured via control-plane signaling or signaled in PDU header rather than provided in a message from the source cell 804 to the target cell 806.

The target cell 806 may then use the buffered data and the PDU Set information to continue handling the reception of the remaining uplink PDUs of the PDU Set(s) 822 that were in transition when the handover occurred. The target cell 806 may receive one or more remaining PDUs, and maintain PDU set state information, at 820, to enable the target cell to handle the PDU sets according to the decoding criteria/content criteria. The target cell 806 may provide feedback 824 to the UE 802.

The handover between the source cell 804 and the target cell 806 may be an Xn handover, for example. The PDU Set information, e.g., as provided at 818, may be included in an Xn handover request message, an Xn PDCP state transfer message, or an early status transfer message.

In some aspects, the handover may be an NG handover, such as described in connection with FIG. 7, and rather than being directly provided from the source cell 804 to the target cell 806, the PDU Set information, shown at 818, may be provided by the source cell to an AMF, which in turn provides the PDU Set information to the target cell.

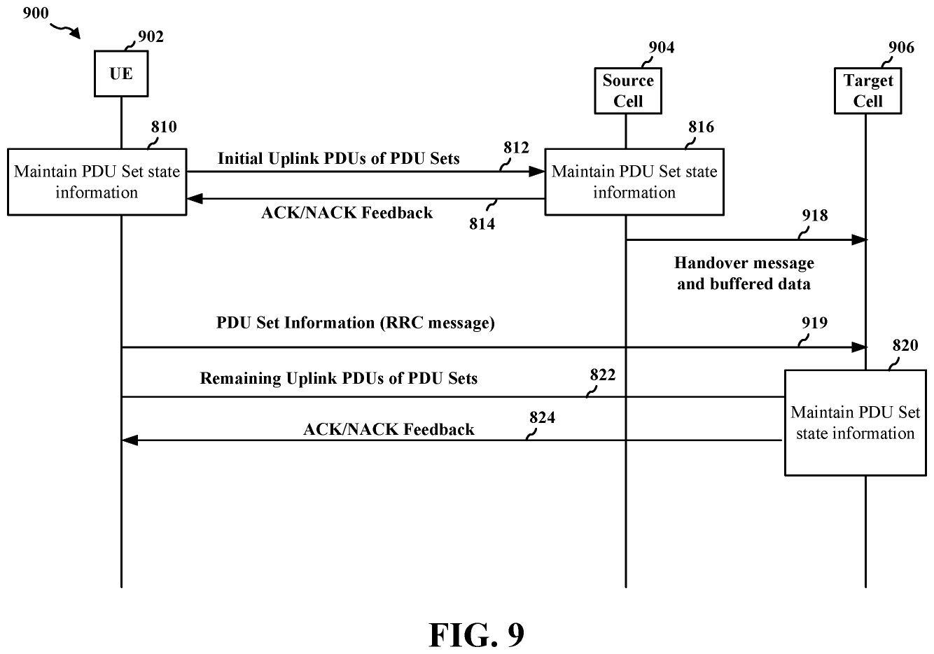

In some aspects, the PDU Set information for one or more uplink PDU Sets may be provided to the target cell by the UE. FIG. 9 illustrates an example communication flow 900 between the UE 902, source cell 904, and target cell 906, which correspond to FIG. 6. FIG. 9 shows similar aspects of the handover and PDU transmission with a same reference number as used in FIG. 8. However, in contrast to FIG. 8, in FIG. 9, the handover message 918 from the source cell 904 provides buffered data but not PDU Set information. Instead, the UE 902 transmits the PDU Set information 919 to the target cell 906. The PDU Set information 919 may include the information described in connection with 818, e.g., a PDU set ID and sequence information about a last transmitted PDU in the PDU Set, a next PDU to be transmitted, or a next PDU to be received for the target cell 906.

During a mobility event, after UE 902 completes the first RACH procedure in the target cell 906, the UE 902 may provide the PDU Set information 919 to the target cell 906. The PDU Set information 919 may be signaled in an RRC message to the target cell 906, such as in UE assistance information included in an RRC message.

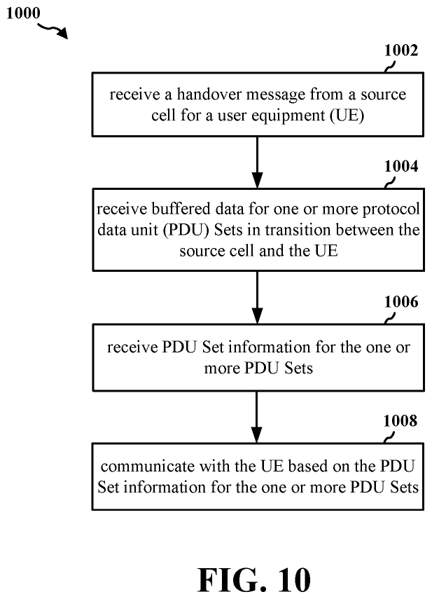

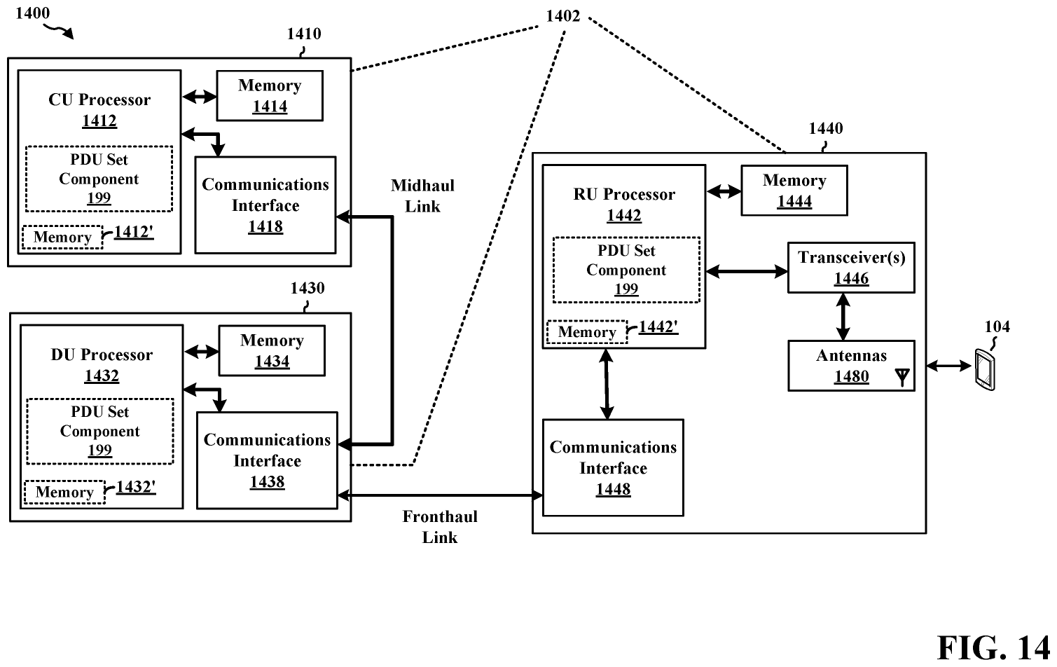

FIG. 10 is a flowchart 1000 of a method of wireless communication. The method may be performed at a base station or other network entity configured as a target cell (e.g., the base station 102, the CU 110, the DU 130, the RU 140, the base station 310, the target cell 606, the target cell 706, the target cell 806, the target cell 906, or the network entity 1402 in the hardware implementation of FIG. 14). For example, the method may be performed by a base station in aggregation or by one or more components of a base station. The method helps to improve handling of PDU sets as a UE during mobility events, such as RRC reconfigurations with synchronization events, e.g., handover, PSCell change, or RRC re-establishment. Aspects presented herein can help to prevent data loss and assist more efficient communication between a network and a UE in connection with mobility events.

As shown in FIG. 10, at 1002, a handover message originating from a source cell is received for a UE. For example, referring to FIG. 6, at 618, the target cell 606 may receive the handover message from the source cell 604. In another example, referring to FIG. 7, at 719, the target cell 706 may receive the handover message from the AMF 708, which is based on the handover message transmitted by the source cell 704 at 718. In a further example, referring to FIG. 8, at 818, the target cell 806 may receive the handover message from the source cell 804. In yet a further example, referring to FIG. 9, at 918, the target cell 906 may receive the handover message from the source cell 904. In some aspects, 1002 may be performed by the PDU set component 199.

At 1004, buffered data for PDU Set(s) in transition between the source cell and the UE may be received. For example, referring to FIG. 6, at 618, the target cell 606 may receive the buffered data for PDU Set(s) in transition between the source cell 604 and the UE 602. In another example, referring to FIG. 7, at 719, the target cell 706 may receive the buffered data for PDU Set(s) in transition between the source cell 704 and the UE 702 from the AMF 708. The buffered data received at 719 is based on the buffered data transmitted by the source cell 704 to the AMF 708 at 718. In another example, referring to FIG. 8, at 818, the target cell 806 may receive the buffered data for PDU Set(s) in transition between the source cell 804 and the UE 802. In another example, referring to FIG. 9, at 918, the target cell 906 may receive the buffered data for PDU Set(s) in transition between the source cell 904 and the UE 902. In some aspects 1004 may be performed by the PDU set component 199.

At 1006, PDU Set information for the PDU Set(s) may be received. For example, referring to FIG. 6, at 618, the target cell 606 may receive the PDU Set information for the PDU Set(s). In another example, referring to FIG. 7, at 718, the target cell 706 may receive the PDU Set information for the PDU Set(s). In a further example, referring to FIG. 8, at 818, the target cell 806 may receive the PDU Set information for the PDU Set(s). In yet a further example, referring to FIG. 9, at 918, the target cell 906 may receive the PDU Set information for the PDU Set(s). In some aspects 1006 may be performed by the PDU set component 199.

In some aspects, the PDU Set information may be received from the source cell. For example, referring to FIG. 6, at 618, the target cell 606 may receive the PDU Set information from the source cell 604. In another example, referring to FIG. 8, at 818, the target cell 806 may receive the PDU Set information from the source cell 804.

In some aspects, the PDU Set information may be received over an Xn interface between the target cell and the source cell. For example, referring to FIG. 6, the PDU Set information received at 618 may be received by the target cell 606 over an Xn interface between the target cell 606 and the source cell 604. In another example, referring to FIG. 8, the PDU Set information received at 818 may be received by the target cell 806 over an Xn interface between the target cell 806 and the source cell 804.

In some aspects, the PDU Set information may be included in at least one of an Xn handover request message, an Xn PDCP state transfer message, or an early state transfer message. For example, referring to FIG. 6, the PDU Set information received at 618 may be included in at least one of an Xn handover request message, an Xn PDCP state transfer message, or an early state transfer message. In another example, referring to FIG. 8, the PDU Set information received at 818 may be included in at least one of an Xn handover request message, an Xn PDCP state transfer message, or an early state transfer message.

In some aspects, the buffered data may include one or more downlink PDU Sets for which at least one PDU was transmitted from the source cell to the UE and has at least one remaining PDU for transmission to the UE. For example, referring to FIG. 6, the buffered data received by the target cell 606 at 618 may include one or more downlink PDU Sets for which at least one PDU was transmitted from the source cell 604 to the UE 602 and has at least one remaining PDU for transmission to the UE 602. In another example, referring to FIG. 7, the buffered data received by the target cell 706 at 719 may include one or more downlink PDU Sets for which at least one PDU was transmitted from the source cell 704 to the UE 702 and has at least one remaining PDU for transmission to the UE 702.

In some aspects, the PDU Set information for a PDU Set may include a PDU Set identifier and indicates a last transmitted PDU, a last discarded PDU, or a next expected PDU within a sequence of the PDU Set. For example, with reference to FIG. 6, the PDU Set information for a PDU Set received at 618 may include a PDU Set identifier and indicates a last transmitted PDU, a last discarded PDU, or a next expected PDU within a sequence of the PDU Set. In another example, with reference to FIG. 7, the PDU Set information for a PDU Set received at 719 may include a PDU Set identifier and indicates a last transmitted PDU, a last discarded PDU, or a next expected PDU within a sequence of the PDU Set.

In some aspects, the PDU Set information may be received from an AMF and is included in one of an NG handover required message from the source cell via the AMF or an NG AP handover request message from the source cell via the AMF. For example, referring to FIG. 7, at 719, the PDU Set information may be received from the AMF 708. The PDU Set information received at 719 may be included in one of an NG handover required message from the source cell 704 via the AMF 708 or an NG AP handover request message from the source cell 704 via the AMF 708.

In some aspects, the buffered data may include uplink PDU Set(s) for which at least one PDU was received at the source cell from the UE and there may be at least one remaining PDU, and the PDU set information may be received for each data radio bearer with at least one associated PDU Set for the UE. For example, referring to FIG. 8, the buffered data received at 818 may include uplink PDU Set(s) for which at least one PDU was received at the source cell 804 from the UE 802 and there may be at least one remaining PDU, and the PDU Set information may be received for each data radio bearer with at least one associated PDU Set for the UE 802. In another example, referring to FIG. 9, the buffered data received at 918 may include uplink PDU Set(s) for which at least one PDU was received at the source cell 904 from the UE 902 and there may be at least one remaining PDU, and the PDU Set information may be received for each data radio bearer with at least one associated PDU Set for the UE 902.

In some aspects, the PDU Set information may be received from the UE. For example, referring to FIG. 9, at 919, the target cell 906 may receive the PDU Set information from the UE 902.

In some aspects, the PDU Set information may be included in UE assistance information in an RRC message from the UE. For example, referring to FIG. 9, the PDU Set information received at 919 may be included in UE assistance information in an RRC message from the UE 902.

In some aspects, the PDU Set information may include a PDU Set identifier for each of the one or more uplink PDU Sets for which the UE initiated transmission to the source cell. For example, referring to FIG. 9, the PDU Set information received at 919 may include a PDU Set identifier for each of the one or more uplink PDU Sets for which the UE 902 initiated transmission to the source cell 904.

In some aspects, for each of the one or more uplink PDU Sets, the PDU Set information may include a sequence number within a sequence of PDUs in a corresponding PDU Set that is expected to be received next. For example, referring to FIG. 9, for each of the one or more uplink PDU Sets, the PDU Set information received at 919 may include a sequence number within a sequence of PDUs in a corresponding PDU Set that is expected to be received next.

In some aspects, for each of the uplink PDU Set(s), the PDU Set information may include a sequence number of a PDU, within a sequence of PDUs in a corresponding PDU Set, that was last discarded. For example, referring to FIG. 8, the PDU Set information received by the target cell 806 at 818 may include a sequence number of a PDU, within a sequence of PDUs in a corresponding PDU Set, that was last discarded.

In some aspects, for each PDU Set of the one or more PDU Sets, the PDU Set information may further include at least one of a PDU size or a content criteria. For example, referring to FIG. 6, for each PDU Set of the one or more PDU Sets, the PDU Set information received at 618 may further include at least one of a PDU size or a content criteria. In another example, referring to FIG. 7, for each PDU Set of the one or more PDU Sets, the PDU Set information received at 719 may further include at least one of a PDU size or a content criteria. In a further example, referring to FIG. 8, for each PDU Set of the one or more PDU Sets, the PDU Set information received at 818 may further include at least one of a PDU size or a content criteria. In yet a further example, referring to FIG. 9, for each PDU Set of the one or more PDU Sets, the PDU Set information received at 919 may further include at least one of a PDU size or a content criteria.

At 1008, the UE may be communicated with based on the PDU Set information for the PDU Set(s). For example, referring to FIG. 6, the target cell 606 may communicate with the UE 602 (e.g., at 622) based on the PDU Set information for the PDU Set(s) received at 618. In another example, referring to FIG. 7, the target cell 706 may communicate with the UE 702 (e.g., at 722) based on the PDU Set information for the PDU Set(s) received at 719. In a further example, the target cell 806 may communicate with the UE 802 (e.g., at 822) based on the PDU Set information for the PDU Set(s) received at 818. In yet a further example, the target cell 906 may communicate with the UE 902 (e.g., at 922) based on the PDU Set information for the PDU Set(s) received at 919. In some aspects 1008 may be performed by the PDU set component 199.

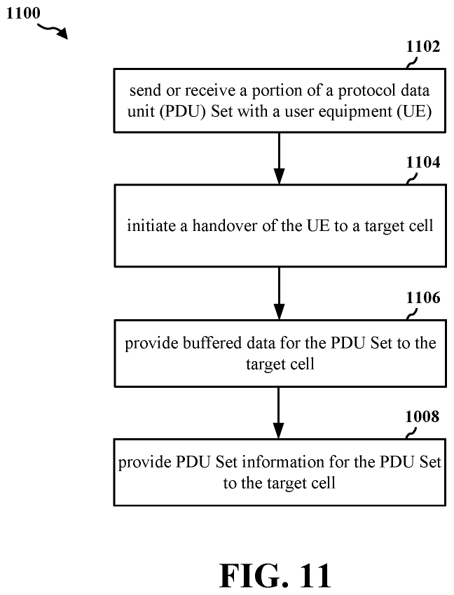

FIG. 11 is a flowchart 1100 of a method of wireless communication. The method may be performed at a base station or other network entity configured as a source cell (e.g., the base station 102, the CU 110, the DU 130, the RU 140, the base station 310, the source cell 604, the source cell 704, the source cell 804, the source cell 904, or the network entity 1402 in the hardware implementation of FIG. 14). For example, the method may be performed by a base station in aggregation or by one or more components of a base station. The method helps to improve handling of PDU sets as a UE during mobility events, such as RRC reconfigurations with synchronization events, e.g., handover, PSCell change, or RRC re-establishment. Aspects presented herein can help to prevent data loss and assist more efficient communication between a network and a UE in connection with mobility events.

As shown in FIG. 11, at 1102, a portion of a PDU Set may be sent or received with a UE. For example, referring to FIG. 6, at 612, the source cell 604 may send a portion of a PDU Set to the UE 602. In another example, referring to FIG. 7, at 712, the source cell 704 may send a portion of a PDU Set to the UE 702. In a further example, referring to FIG. 8, at 812, the source cell 804 may receive a portion of a PDU Set from the UE 802. In yet a further example, referring to FIG. 9, at 912, the source cell 904 may receive a portion of a PDU Set from the UE 902. In some aspects, 1102 may be performed by the PDU set component 199.

At 1104, a handover of the UE to a target cell may be initiated. For example, referring to FIG. 6, at 618, the source cell 604 may initiate a handover of the UE 602 to the target cell 606. In another example, referring to FIG. 7, at 718, the source cell 704 may transmit a handover message to the AMF 708, and the AMF 708 may transmit the handover message to the target cell 706 at 719. In another example, referring to FIG. 8, at 818, the source cell 804 may initiate a handover of the UE 802 to the target cell 806. In yet another example, referring to FIG. 9, at 918, the source cell 904 may initiate a handover of the UE 902 to the target cell 806. In some aspects, 1104 may be performed by the PDU set component 199.

At 1106, buffered data for the PDU Set may be provided to the target cell. For example, referring to FIG. 6, at 618, the source cell 604 may provide buffered data for the PDU Set to the target cell 606. In another example, referring to FIG. 7, at 718, the source cell 704 may provide buffered data to the AMF 708, and the AMF 708 may provide the buffered data the target cell 706 at 719. In a further example, referring to FIG. 8, at 818, the source cell 804 may provide buffered data for the PDU Set to the target cell 806. In yet a further example, referring to FIG. 9, at 918, the source cell 904 may provide buffered data for the PDU Set to the target cell 906. In some aspects, 1106 may be performed by the PDU set component 199.

At 1108, PDU Set information for the PDU Set may be provided to the target cell. For example, referring to FIG. 6, at 618, the source cell 604 may provide the PDU Set information for the PDU Set to the target cell 606. In another example, referring to FIG. 7, at 718, the source cell 704 may provide the PDU Set information for the PDU Set to the AMF 708, and the AMF 708 may provide the PDU Set information to the target cell 706 at 719. In a further example, referring to FIG. 8, at 818, the source cell 804 may provide the PDU Set information for the PDU Set to the target cell 806. In some aspects, 1106 may be performed by the PDU set component 199.

In some aspects, the PDU Set information may be sent over an Xn interface between the target cell and the source cell. For example, referring to FIG. 6, at 618, the PDU Set information may be sent by the source cell 604 to the target cell 606 over an Xn interface between the target cell 606 and the source cell 604. In another example, referring to FIG. 8, the PDU Set information may be sent by the source cell 804 to the target cell 806 over an Xn interface between the target cell 806 and the source cell 804.

In some aspects, the PDU Set information may be included in one of an Xn handover request message, an Xn PDCP state transfer message, or an early state transfer message. For example, referring to FIG. 6, the PDU Set information sent by the source cell 604 at 618 may be included in one of an Xn handover request message, an Xn PDCP state transfer message, or an early state transfer message. In another example, referring to FIG. 8, the PDU Set information sent by the source cell 804 at 818 may be included in one of an Xn handover request message, an Xn PDCP state transfer message, or an early state transfer message.

In some aspects, the PDU Set information may be provided to an AMF for forwarding to the target cell in one of an NG handover required message or an NG AP handover request message. For example, referring to FIG. 7, the source cell 704, at 718, may provide the PDU Set information to the AMF 708 for forwarding to the target cell 706 (e.g., at 719) in one of an NG handover required message or an NG AP handover request message.

In some aspects, the buffered data includes a downlink PDU Set for which at least one PDU was transmitted from the source cell to the UE and there is at least one remaining PDU for transmission to the UE. For example, referring to FIG. 6, the buffered data sent by the source cell 604 at 618 may include a downlink PDU Set for which at least one PDU was transmitted from the source cell 604 to the UE 602 and there is at least one remaining PDU for transmission to the UE 602. In another example, referring to FIG. 7, the buffered data sent by the source cell 704 at 718 may include a downlink PDU Set for which at least one PDU was transmitted from the source cell 704 to the UE 702 and there is at least one remaining PDU for transmission to the UE 702.

In some aspects, the PDU Set information for the PDU Set may include a PDU Set identifier and further indicates a last transmitted PDU, a last discarded PDU, or a next expected PDU within a sequence of the PDU Set. For example, referring to FIG. 6, the PDU Set information sent by the source cell 604 at 618 may include a PDU Set identifier and further indicates a last transmitted PDU, a last discarded PDU, or a next expected PDU within a sequence of the PDU Set. In another example, referring to FIG. 7, the PDU Set information sent by the source cell 704 at 718 may include a PDU Set identifier and further indicates a last transmitted PDU, a last discarded PDU, or a next expected PDU within a sequence of the PDU Set.

In some aspects, the PDU set may be an uplink PDU Set. For example, referring to FIG. 8, the PDU Set received at 812 by the source cell 804 is an uplink PDU Set. In another example, referring to FIG. 9, the PDU Set received at 912 by the source cell 904 is an uplink PDU Set.

In some aspects, the PDU Set information may include a PDU Set identifier for the uplink PDU Set for which the source cell has received at least one PDU and has at least one remaining from the UE, and the PDU Set information includes a sequence number within a sequence of PDUs in a corresponding PDU Set that is expected to be received next. For example, referring to FIG. 8, the PDU Set information sent by the source cell 804 at 818 may include a PDU Set identifier for each of one or more uplink PDU Sets for which the source cell 804 has received at least one PDU and has at least one remaining from the UE 802, and the PDU Set information includes a sequence number within a sequence of PDUs in a corresponding PDU Set that is expected to be received next.

In some aspects, the PDU Set information may include a sequence number of a PDU, within a sequence of PDUs in a corresponding PDU Set, that was last discarded. For example, referring to FIG. 8, the PDU Set information sent by the source cell 804 at 818 may include a sequence number of a PDU, within a sequence of PDUs in a corresponding PDU Set, that was last discarded.

In some aspects, the PDU Set information may further include at least one of a PDU size or a content criteria for the PDU set. For example, referring to FIG. 6, the PDU Set information sent by the source cell 604 at 618 may further include at least one of a PDU size or a content criteria for the PDU set. In another example, referring to FIG. 7, the PDU Set information sent by the source cell 704 at 718 may further include at least one of a PDU size or a content criteria for the PDU set. In a further example, the PDU Set information sent by the source cell 804 at 818 may further include at least one of a PDU size or a content criteria for the PDU set.

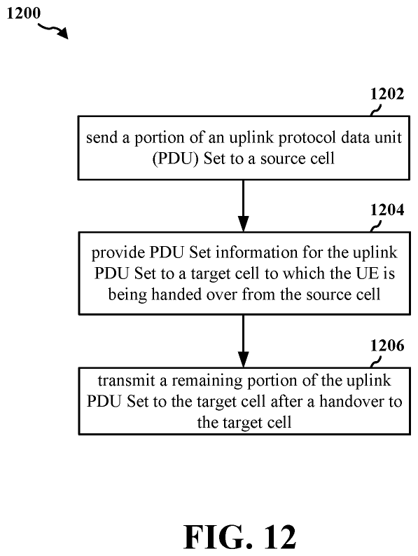

FIG. 12 is a flowchart 1200 of a method of wireless communication. The method may be performed at a UE (e.g., the UE 104, the UE 350, the UE 602, the UE 702, the UE 802, the UE 902, or the apparatus 13). The method helps to improve handling of PDU sets for a UE when a UE experiences mobility events, such as RRC reconfigurations with synchronization events, e.g., handover, PSCell change, or RRC re-establishment. Aspects presented herein can help to prevent data loss and assist more efficient communication between a network and a UE in connection with mobility events.

As shown in FIG. 12, at 1202, a portion of an uplink PDU may be sent to a source cell. For example, referring to FIG. 9, at 912, the UE 902 may send a portion of an uplink PDU to the source cell 904. In some aspects, 1202 may be performed by the PDU set component 198. For example, FIG. 9 illustrates an example of a UE sending uplink PDUs.

At 1204, PDU Set information for the uplink PDU Set may be provided to a target cell to which the UE is being handed over from the source cell. For example, referring to FIG. 9, at 919, the UE 902 may provide PDU Set information for the uplink PDU Set to the target cell 906 to which the UE 902 is being handed over from the source cell 904. In some aspects, 1208 may be performed by the PDU set component 198. As an example, FIG. 9 illustrates an example of a UE sending PDU set information to a target cell.

In some aspects, the PDU Set information may be included in an RRC message from the UE. For example, referring to FIG. 9, the PDU Set information provided by the UE 902 at 919 may be included in an RRC message from the UE 902.

In some aspects, the PDU Set information may include a PDU Set identifier for the uplink PDU Set for which the UE transmitted at least one PDU to the source cell and has at least one remaining PDU for transmission, and the PDU Set information includes a sequence number within a sequence of PDUs in a corresponding PDU Set for which the target cell is to expect to receive next. For example, referring to FIG. 9, the PDU Set information provided by the UE 902 at 919 may include a PDU Set identifier for the uplink PDU Set for which the UE 902 transmitted at least one PDU to the source cell 904 and has at least one remaining PDU for transmission, and the PDU Set information includes a sequence number within a sequence of PDUs in a corresponding PDU Set for which the target cell 906 is to expect to receive next.

In some aspects, the PDU Set information may further include at least one of a PDU size or a content criteria. For example, referring to FIG. 9, the PDU Set information provided by the UE 902 at 919 may further include at least one of a PDU size or a content criteria.

At 1206, a remaining portion of the uplink PDU Set may be transmitted to the target cell after a handover to the target cell. For example, referring to FIG. 9, at 922, the UE may transmit a remaining portion of the uplink PDU Set to the target cell 906 after a handover to the target cell 906. In some aspects, 1206 may be performed by the PDU set component 198.

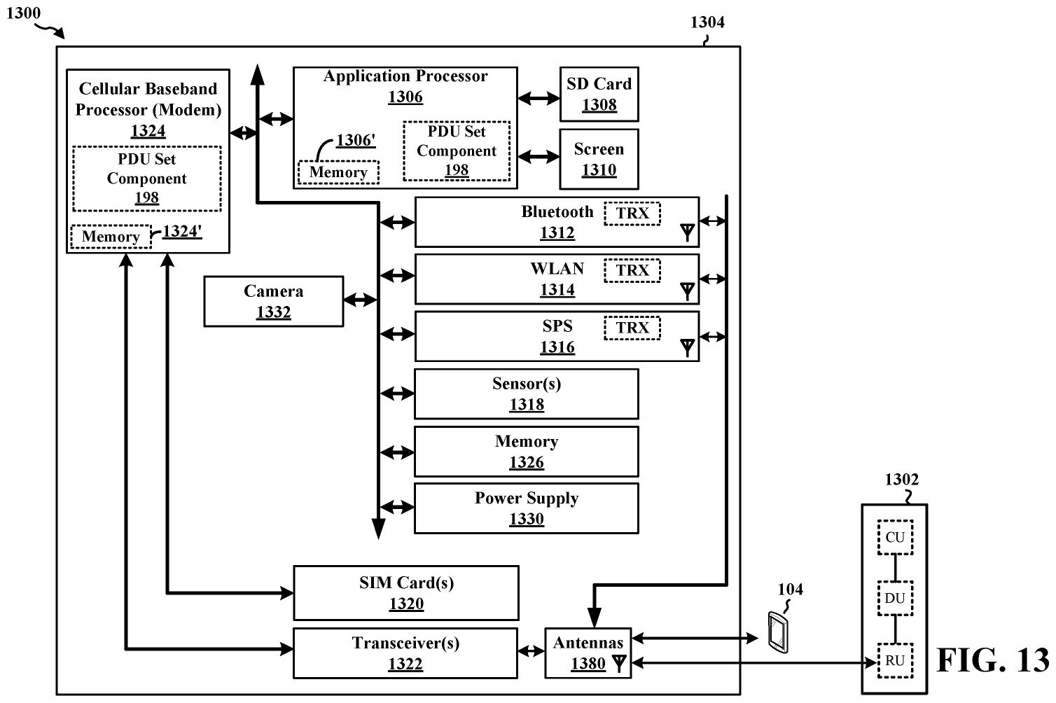

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem or processor circuitry) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 (or processor circuitry) coupled to a secure digital (SD) card 1308 and a screen 1310. The application processor 1306 may include at least one on-chip memory 1306′ (or memory circuitry). In some aspects, the apparatus 1304 may further include a Bluetooth™ module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory (e.g., 1324′, 1306′, 1326) may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. In some aspects, the software, when executed by the cellular baseband processor 1324/application processor 1306, can be described as causing the apparatus (e.g., which may be a UE) to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the PDU set component 198 may be configured to send a portion of an uplink PDU Set to a source cell, provide PDU set information for the uplink PDU Set to a target cell to which the UE is being handed over from the source cell, and transmit a remaining portion of the uplink PDU Set to the target cell after a handover to the target cell. The PDU set component 198 may be further configured to perform any of the aspects described in connection with the flowchart in FIG. 12 and/or any of the aspects performed by the UE in FIGS. 6, 7, 8, and/or 9. The PDU set component 198 may be within the cellular baseband processor 1324, the application processor 1306, or both the cellular baseband processor 1324 and the application processor 1306. The PDU set component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor 1324 and/or the application processor 1306, includes means for sending a portion of an uplink PDU Set to a source cell, means for providing PDU set information for the uplink PDU Set to a target cell to which the UE is being handed over from the source cell, and means for transmitting a remaining portion of the uplink PDU Set to the target cell after a handover to the target cell. The apparatus may further include means for performing any of the aspects described in connection with the flowchart in FIG. 12 and/or any of the aspects performed by the UE in FIGS. 6, 7, 8, and/or 9. The means may be the PDU set component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. In some instances, the network entity may be a source cell in a handover, and in other instances the network entity may be a target cell in a handover. The network entity 1402 may be a base station, a component of a base station, or may implement base station functionality. The network entity 1402 may include at least one of a CU 1410, a DU 1430, or an RU 1440. For example, depending on the layer functionality handled by the PDU set component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412 (or processor circuitry). The CU processor 1412 may include at least one on-chip memory 1412′ (or memory circuitry). In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432 (or processor circuitry). The DU processor 1432 may include at least one on-chip memory 1432′ (or memory circuitry). In some aspects, the DU 1430 may further include additional memory modules 1434 and a communications interface 1438. The DU 1430 communicates with the RU 1440 through a fronthaul link. The RU 1440 may include at least one RU processor 1442 (or processor circuitry). The RU processor 1442 may include at least one on-chip memory 1442′ (or memory circuitry). In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the network entity 1402 may be configured as a target cell (e.g., in a handover), and the PDU set component 199 may be configured to receive a handover message from a source cell for a UE, receive buffered data for one or more PDU Sets in transition between the source cell and the UE, receive PDU Set information for the one or more PDU Sets, and communicate with the UE based on the PDU Set information for the one or more PDU Sets. The PDU set component 199 may be further configured to perform any of the aspects described in connection with the flowchart in FIG. 10 and/or any of the aspects performed by the target cell in FIGS. 6, 7, 8, and/or 9. As further discussed supra, the network entity 1402 may be configured as a source cell (e.g., in a handover), and the PDU set component 199 may be configured to send or receive a portion of a PDU Set with a UE, initiate a handover of the UE to a target cell, provide buffered data for the PDU Set to the target cell, and provide PDU set information for the PDU Set to the target cell. The PDU set component 199 may be further configured to perform any of the aspects described in connection with the flowchart in FIG. 11 and/or any of the aspects performed by the source cell in FIGS. 6, 7, 8, and/or 9. The PDU set component 199 may be within one or more processors of one or more of the CU 1410, DU 1430, and the RU 1440. The PDU set component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for receiving a handover message from a source cell for a UE, receiving buffered data for one or more PDU Sets in transition between the source cell and the UE, receiving PDU Set information for the one or more PDU Sets, and communicating with the UE based on the PDU Set information for the one or more PDU Sets. In another configuration, the network entity 1402 includes means for sending or receiving a portion of a PDU Set with a UE, initiating a handover of the UE to a target cell, providing buffered data for the PDU Set to the target cell, and providing PDU set information for the PDU Set to the target cell. The network entity may further include means for performing any of the aspects described in connection with the flowchart in FIG. 10 or 11 and/or any of the aspects performed by the target cell or the source cell in FIGS. 6, 7, 8, and/or 9. The means may be the PDU set component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

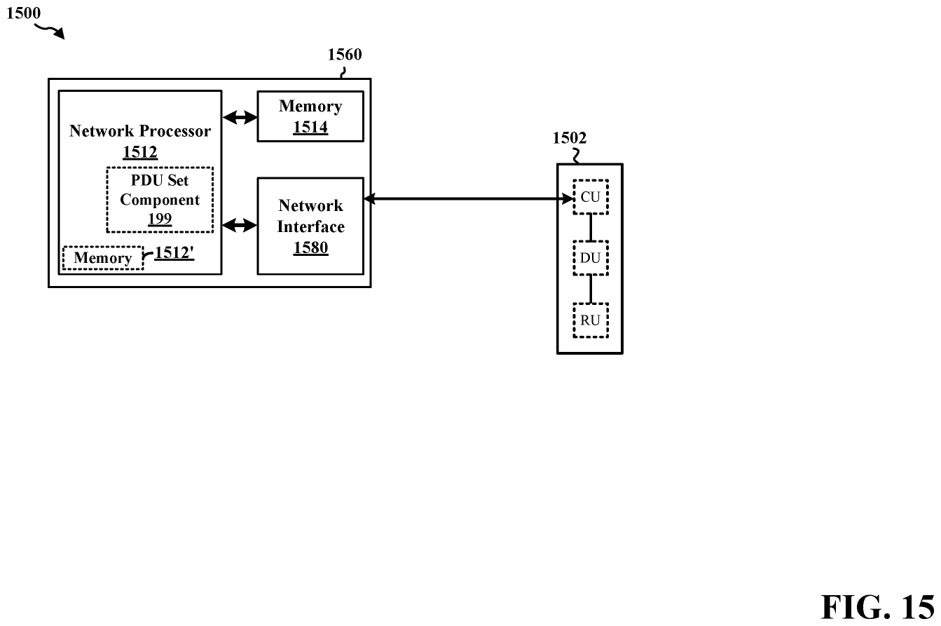

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the PDU Set component 199 is configured to perform the features described above for AMF 708 (e.g., receiving a handover message from a source cell and transmitting the handover message to a target cell, receiving, from the source cell, buffered data for PDU Set(s) in transition between the source cell and a UE from the source cell and transmitting the buffered data to the target cell, and/or receiving, from the source cell, PDU Set information for the PDU Set(s), and transmitting the PDU Set information to the target cell. The PDU Set component 199 may be within the processor 1512. The PDU Set component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1560 The network entity 1560 may include a variety of components configured for various functions. In one configuration, the network entity 1560 includes means for receiving a handover message from a source cell and means for transmitting the handover message to a target cell, means for receiving, from the source cell, buffered data for PDU Set(s) in transition between the source cell and a UE from the source cell and means for transmitting the buffered data to the target cell, and/or means for receiving, from the source cell, PDU Set information for the PDU Set(s), and means for transmitting the PDU Set information to the target cell. The means may be the PDU Set component 199 of the network entity 1560 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (e.g., one or more processors) is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a target cell, comprising receiving a handover message originating from a source cell for a UE, receiving buffered data for one or more PDU Sets in transition between the source cell and the UE, receiving PDU Set information for the one or more PDU Sets, and communicating with the UE based on the PDU Set information for the one or more PDU Sets.

Aspect 2 is the method of aspect 1, wherein the PDU Set information is received from the source cell.

Aspect 3 is the method of aspect 2, wherein the PDU Set information is received over an Xn interface between the target cell and the source cell.

Aspect 4 is the method of aspect 3, wherein the PDU Set information is comprised in at least one of: an Xn handover request message, an Xn PDCP state transfer message, or an early state transfer message.

Aspect 5 is the method of any of aspects 1 to 4, wherein the buffered data comprises one or more downlink PDU Sets for which at least one PDU was transmitted from the source cell to the UE and has at least one remaining PDU for transmission to the UE.

Aspect 6 is the method of aspect 5, wherein the PDU Set information for a PDU Set includes a PDU Set identifier and indicates a last transmitted PDU, a last discarded PDU, or a next expected PDU within a sequence of the PDU Set.

Aspect 7 is the method of any of aspects 5 to 6, wherein the PDU Set information is received from an AMF and is comprised in one of: an NG handover required message from the source cell via the AMF, or an NG AP handover request message from the source cell via the AMF.

Aspect 8 is the method of aspect 1, wherein the buffered data comprises one or more uplink PDU Sets for which at least one PDU was received at the source cell from the UE and there is at least one remaining PDU, and the PDU set information is received for each data radio bearer with at least one associated PDU Set for the UE.

Aspect 9 is the method of aspect 8, wherein the PDU Set information is comprised in UE assistance information in an RRC message from the UE.

Aspect 10 is the method of aspect 9, wherein the PDU Set information is comprised in UE assistance information in an RRC message from the UE.

Aspect 11 is the method of aspect 10, wherein the PDU Set information includes a PDU Set identifier for each of the one or more uplink PDU Sets for which the UE initiated transmission to the source cell.

Aspect 12 is the method of aspect 11, wherein for each of the one or more uplink PDU Sets, the PDU Set information includes a sequence number within a sequence of PDUs in a corresponding PDU Set that is expected to be received next.

Aspect 13 is the method of aspect 11, wherein for each of the one or more uplink PDU Sets, the PDU Set information includes a sequence number of a PDU, within a sequence of PDUs in a corresponding PDU Set, that was last discarded.

Aspect 14 is the method of any of aspects 1 to 13, wherein, for each PDU Set of the one or more PDU Sets, the PDU Set information further includes at least one of a PDU size or a content criteria.

Aspect 15 is a method of wireless communication at a source cell, comprising sending or receiving a portion of a PDU Set with a UE, initiating a handover of the UE to a target cell, providing buffered data for the PDU Set to the target cell, and providing PDU set information for the PDU Set to the target cell.

Aspect 16 is a method of aspect 15, wherein the PDU Set information is sent over an Xn interface between the target cell and the source cell.

Aspect 17 is a method of aspect 16, wherein the PDU Set information is comprised in one of: an Xn handover request message, an Xn PDCP state transfer message, or an early state transfer message.

Aspect 18 is a method of aspect 15, wherein the PDU Set information is provided to an AMF for forwarding to the target cell in one of an NG handover required message, or an NG AP handover request message.

Aspect 19 is a method of any of the aspects of 15 to 18, wherein the buffered data comprises a downlink PDU Set for which at least one PDU was transmitted from the source cell to the UE and there is at least one remaining PDU for transmission to the UE.

Aspect 20 is a method of aspect 19, wherein the PDU Set information for the PDU set includes a PDU Set identifier and further indicates a last transmitted PDU, a last discarded PDU, or a next expected PDU within a sequence of the PDU Set.

Aspect 21 is a method of aspect 15, wherein the PDU Set is an uplink PDU Set.

Aspect 22 is a method of aspect 21, wherein the PDU Set information includes a PDU Set identifier for each of one or more uplink PDU Sets for which the source cell has received at least one PDU and has at least one remaining from the UE, and the PDU Set information includes a sequence number within a sequence of PDUs in a corresponding PDU Set that is expected to be received next.

Aspect 23 is a method of aspect 21, wherein, the PDU Set information further includes at least one of a PDU size or a content criteria for the PDU Set.

Aspect 24 is a method of any of the aspects of 15 to 23, wherein, the PDU Set information further includes at least one of a PDU size or a content criteria for the PDU set.

Aspect 25 is a method of wireless communication at a UE, comprising sending a portion of an uplink PDU Set to a source cell, providing PDU set information for the uplink PDU Set to a target cell to which the UE is being handed over from the source cell, and transmitting a remaining portion of the uplink PDU Set to the target cell after a handover to the target cell.

Aspect 26 is a method of aspect 25, wherein the PDU Set information is comprised in an RRC message from the UE.

Aspect 27 is a method of any of the aspects of 25 to 26, wherein the PDU Set information includes a PDU Set identifier for each of one or more uplink PDU Sets for which the UE transmitted at least one PDU to the source cell and has at least one remaining PDU for transmission, and the PDU Set information includes a sequence number within a sequence of PDUs in a corresponding PDU Set for which the target cell is to expect to receive next.

Aspect 28 is a method of any of the aspects of 25 to 27, wherein, for each PDU Set of the one or more uplink PDU Sets, the PDU Set information further includes at least one of a PDU size or a content criteria.

Aspect 29 is an apparatus for wireless communication at a target cell comprising memory and at least one processor coupled to the memory and, based at least in part on information stored in the memory, the at least one processor is configured, individually or in any combination, to implement any of aspects 1 to 14.

In aspect 30, the apparatus of aspect 29 further includes at least one transceiver coupled to the at least one processor.

Aspect 31 is an apparatus for wireless communication at a source cell comprising memory and at least one processor coupled to the memory and, based at least in part on information stored in the memory, the at least one processor is configured, individually or in any combination, to implement any of aspects 15 to 24.

In aspect 32, the apparatus of aspect 31 further includes at least one transceiver coupled to the at least one processor.

Aspect 33 is an apparatus for wireless communication at a UE comprising memory and at least one processor coupled to the memory and, based at least in part on information stored in the memory, the at least one processor is configured, individually or in any combination, to implement any of aspects 25 to 28.

In aspect 34, the apparatus of aspect 33 further includes at least one transceiver coupled to the at least one processor.

Aspect 35 is an apparatus for wireless communication including means for implements any of aspects 1 to 14.

Aspect 36 is an apparatus for wireless communication including means for implements any of aspects 15 to 24.

Aspect 37 is an apparatus for wireless communication including means for implements any of aspects 25 to 28.

Aspect 38 is a computer-readable medium (e.g., a non-transitory computer-readable medium) storing computer executable code, the code when executed by at least one processor causes the at least one processor to implement any of aspects 1 to 14.

Aspect 39 is a computer-readable medium (e.g., a non-transitory computer-readable medium) storing computer executable code, the code when executed by at least one processor causes the at least one processor to implement any of aspects 15 to 24.

Aspect 40 is a computer-readable medium (e.g., a non-transitory computer-readable medium) storing computer executable code, the code when executed by at least one processor causes the at least one processor to implement any of aspects 25 to 28.

What is claimed is:

1. An apparatus for wireless communication at a target cell, comprising:
at least one memory; and
at least one processor coupled to the at least one memory and, based at least in part on information stored in the at least one memory, the at least one processor, individually or in combination, is configured to cause the target cell to:
receive a handover message originating from a source cell for a user equipment (UE);
receive buffered data for one or more protocol data unit (PDU) Sets in transition between the source cell and the UE;
receive PDU Set information for the one or more PDU Sets; and
communicate with the UE based on the PDU Set information for the one or more PDU Sets.

2. The apparatus of claim 1, wherein the PDU Set information is from the source cell.

3. The apparatus of claim 2, wherein the at least one processor is configured, individually or in any combination, to cause the target cell to receive the PDU Set information over an Xn interface between the target cell and the source cell.

4. The apparatus of claim 3, wherein the PDU Set information is comprised in at least one of:
an Xn handover request message,
an Xn packet data convergence protocol (PDCP) state transfer message, or
an early state transfer message.

5. The apparatus of claim 2, wherein the buffered data comprises one or more downlink PDU Sets for which at least one PDU was transmitted from the source cell to the UE and has at least one remaining PDU for transmission to the UE.

6. The apparatus of claim 5, wherein the PDU Set information for a PDU Set includes a PDU Set identifier and indicates a last transmitted PDU, a last discarded PDU, or a next expected PDU within a sequence of the PDU Set.

7. The apparatus of claim 5, wherein the PDU Set information is received from an access and mobility management function (AMF) and is comprised in one of:
an NG handover required message from the source cell via the AMF, or
an NG application protocol (AP) handover request message from the source cell via the AMF.

8. The apparatus of claim 1, wherein the buffered data comprises one or more uplink PDU Sets for which at least one PDU was received at the source cell from the UE and there is at least one remaining PDU, and the PDU Set information is received for each data radio bearer with at least one associated PDU Set for the UE.

9. The apparatus of claim 1, wherein, for each PDU Set of the one or more PDU Sets, the PDU Set information further includes at least one of a PDU size or a content criteria.

10. The apparatus of claim 1, further comprising:
at least one transceiver coupled to the at least one processor, wherein the at least one processor is configured to transmit or receive communication with the UE via the at least one transceiver.

11. An apparatus for wireless communication at a source cell, comprising:
at least one memory; and
at least one processor coupled to the at least one memory and, based at least in part on information stored in the at least one memory, the at least one processor, individually or in any combination, is configured to cause the source cell to:
send or receive a portion of a protocol data unit (PDU) Set with a user equipment (UE);
initiate a handover of the UE to a target cell;
provide buffered data for the PDU Set to the target cell; and
provide PDU Set information for the PDU Set to the target cell.

12. The apparatus of claim 11, wherein the at least one processor is configured, individually or in any combination, to cause the source cell to send the PDU Set information over an Xn interface between the target cell and the source cell, and wherein the PDU Set information is comprised in one of:
an Xn handover request message,
an Xn packet data convergence protocol (PDCP) state transfer message, or
an early state transfer message.

13. The apparatus of claim 11, wherein the at least one processor is configured, individually or in any combination, to cause the source cell to provide the PDU Set information to an access and mobility management function (AMF) for forwarding to the target cell in one of:
an NG handover required message, or
an NG application protocol (AP) handover request message.

14. The apparatus of claim 11, wherein the buffered data comprises a downlink PDU Set for which at least one PDU was transmitted from the source cell to the UE and there is at least one remaining PDU for transmission to the UE, and wherein the PDU Set information for the PDU Set includes a PDU Set identifier and further indicates a last transmitted PDU, a last discarded PDU, or a next expected PDU within a sequence of the PDU Set.

15. The apparatus of claim 11, wherein the PDU Set is an uplink PDU Set, and wherein the PDU Set information includes at least one of:
a PDU Set identifier for the uplink PDU Set for which the source cell has received at least one PDU and has at least one remaining from the UE, and the PDU Set information includes a sequence number within a sequence of PDUs in a corresponding PDU Set that is expected to be received next,
a sequence number of a PDU, within the sequence of PDUs in the corresponding PDU Set, that was last discarded,
a PDU size, or
a content criteria for the PDU Set.

16. The apparatus of claim 11, further comprising:
at least one transceiver coupled to the at least one processor, wherein the at least one transceiver is configured to transmit or receive the portion of the PDU Set with the UE via the at least one transceiver.

17. A method of wireless communication at a target cell, comprising:
receiving a handover message originating from a source cell for a user equipment (UE);
receiving buffered data for one or more protocol data unit (PDU) Sets in transition between the source cell and the UE;
receiving PDU Set information for the one or more PDU Sets; and
communicating with the UE based on the PDU Set information for the one or more PDU Sets.

18. The method of claim 17, wherein the PDU Set information is received from the source cell.

19. The method of claim 18, wherein the PDU Set information is received over an Xn interface between the target cell and the source cell, and wherein the PDU Set information is comprised in at least one of:
an Xn handover request message,
an Xn packet data convergence protocol (PDCP) state transfer message, or
an early state transfer message.

20. The method of claim 18, wherein the buffered data comprises one or more downlink PDU Sets for which at least one PDU was transmitted from the source cell to the UE and has at least one remaining PDU for transmission to the UE.

21. The method of claim 20, wherein the PDU Set information for a PDU Set includes a PDU Set identifier and indicates a last transmitted PDU, a last discarded PDU, or a next expected PDU within a sequence of the PDU Set.

22. The method of claim 20, wherein the PDU Set information is received from an access and mobility management function (AMF) and is comprised in one of:
an NG handover required message from the source cell via the AMF, or
an NG application protocol (AP) handover request message from the source cell via the AMF.

23. The method of claim 17, wherein the buffered data comprises one or more uplink PDU Sets for which at least one PDU was received at the source cell from the UE and there is at least one remaining PDU, and the PDU Set information is received for each data radio bearer with at least one associated PDU Set for the UE.

24. The method of claim 17, wherein, for each PDU Set of the one or more PDU Sets, the PDU Set information further includes at least one of a PDU size or a content criteria.

25. A method of wireless communication at a source cell, comprising:
sending or receiving a portion of a protocol data unit (PDU) Set with a user equipment (UE);
initiating a handover of the UE to a target cell;
providing buffered data for the PDU Set to the target cell; and
providing PDU Set information for the PDU Set to the target cell.

26. The method of claim 25, wherein the PDU Set information is sent over an Xn interface between the target cell and the source cell.

27. The method of claim 26, wherein the PDU Set information is comprised in one of:
an Xn handover request message,
an Xn packet data convergence protocol (PDCP) state transfer message, or
an early state transfer message.

28. The method of claim 25, wherein the PDU Set information is provided to an access and mobility management function (AMF) for forwarding to the target cell in one of:
an NG handover required message, or
an NG application protocol (AP) handover request message.

29. The method of claim 25, wherein the buffered data comprises a downlink PDU Set for which at least one PDU was transmitted from the source cell to the UE and there is at least one remaining PDU for transmission to the UE, and wherein the PDU Set information for the PDU Set includes a PDU Set identifier and further indicates a last transmitted PDU, a last discarded PDU, or a next expected PDU within a sequence of the PDU Set.

30. The method of claim 25, wherein the PDU Set is an uplink PDU Set, and wherein the PDU Set information includes at least one of:
a PDU Set identifier for the uplink PDU Set for which the source cell has received at least one PDU and has at least one remaining from the UE, and the PDU Set information includes a sequence number within a sequence of PDUs in a corresponding PDU Set that is expected to be received next,
a sequence number of a PDU, within the sequence of PDUs in the corresponding PDU Set, that was last discarded,
a PDU size, or
a content criteria for the PDU Set.
